(19) United States
(12) Patent Application Publication
(10) Pub. No.: US 2012/0080655 A1
(43) Pub. Date: Apr. 5, 2012

(54) SAFETY HAND RAIL

(76) Inventor: David Coffin, Pocatello, ID (US)

(21) Appl. No.: 13/253,406

(22) Filed: Oct. 5, 2011

Related U.S. Application Data
(60) Provisional application No. 61/389,798, filed on Oct. 5, 2010.
(60) Provisional application No. 61/393,443, filed on Oct. 15, 2010.

(51) Int. Cl. E04F 11/18; B23P 11/00

(52) U.S. Cl. 256/19; 29/525.01

(57) ABSTRACT

A temporary safety railing system includes a plurality of upright support structures. Each support structure includes a base member configured for temporary attachment to a support surface, an upright member attached to the base member and a plurality of C-shaped mounting brackets rotatably attached to each upright member on the same side thereof in a longitudinally spaced relationship with an upper mounting bracket positioned proximate a top end of each upright member and a lower mounting bracket positioned a distance below the upper mounting bracket. A plurality of wood upper railing members are attached to the upper mounting brackets and lower railing members are attached to the lower mounting brackets. The upper and lower railing members span a distance between adjacent support structures.

### CROSS-REFERENCE TO RELATED APPLICATIONS

The present application claims priority to U.S. Provisional Patent Application Ser. No. 61/389798 filed on Oct. 5, 2010 and U.S. Provisional Patent Application Ser. No. 61/393,443 filed on Oct. 15, 2010, the entirety of each of which is incorporated by this reference.

### FIELD OF THE INVENTION

The present invention relates generally to hand rails, and more specifically, to a temporarily installed handrail system used during new building construction along staircases and balconies.

### STATE OF THE RELATED ART

In housing and small building construction where the dwelling includes more than one story or a basement, the foundation of a staircase will necessarily be built to allow access by construction workers to the various levels of the structure being built. In addition, interior and exterior balconies are often built. In such situations, where a carpenter-built staircase is constructed, once the foundation of the staircase has been built, which in a carpenter-built staircase includes the stringer and roughed-in treads, the handrail is not installed until finish work is being completed on the home or building. Moreover, it may be some time that a railing is installed along the edge of a balcony. At best, there may be crude attempts to nail a series of 2×4 wood studs to erect a temporary handrail while construction is being completed. Such temporary handrails, however, often lack necessary structural support that would actually prevent a worker or other person from breaking through the temporary handrail system when falling and are more often than not present to simply warn a worker or other person of a drop. Moreover, when such temporary handrails are constructed of lumber, such lumber often become unusable for other purposes since it has been cut to a length to accommodate the construction of the temporary handrail system. In areas where lumber is particularly expensive, it is often the case that such temporary handrail systems are not even erected in order to save lumber.

As a result, there has existed an enormous safety hazard in the construction industry for decades where no or inadequate handrails or railings are erected along staircases and balconies. The result has been numerous injuries and even deaths in the construction business due to carpenters falling down stairs or over balconies. The potential liability for such falls to the construction company or contractor can be significant. Thus, there exists a need in the art to provide a temporary handrail and railing system that can be easily installed during construction of a home or building, is sufficiently strong to prevent the handrail or railing from being breached during a fall, that is relatively inexpensive and that does not significantly increase the amount of lumber needed for the construction project.

The advantages and characterizing features will become apparent from the following description of certain illustrative embodiments of the invention. The features and advantages of the present invention are set forth or will become more fully apparent in the detailed description that follows. Furthermore, the features and advantages of the present invention may be learned by the practice of the invention and will become apparent to one skilled in the art upon review of the description, as set forth hereinafter.

### SUMMARY OF THE INVENTION

A temporary safety railing system includes a plurality of upright support structures. Each support structure includes a base member configured for temporary attachment to a support surface, an upright member attached to the base member and a plurality of C-shaped mounting brackets rotatably attached to each upright member on the same side thereof in a longitudinally spaced relationship with an upper mounting bracket positioned proximate a top end of each upright member and a lower mounting bracket positioned a distance below the upper mounting bracket. A plurality of wood upper railing members are attached to the upper mounting brackets and lower railing members are attached to the lower mounting brackets. The upper and lower railing members span a distance between adjacent support structures.

In one embodiment, each of the plurality of mounting brackets are releasably attached to the plurality of support structures.

In another embodiment, the railing members are comprised standard studs.

In still another embodiment, each of the railing members are attached to the plurality of brackets with a plurality of threaded fasteners that can be removed after use.

In still another embodiment, each of the plurality of brackets has a top portion for extending over a top surface of a railing member having at least one hole formed therein for receiving a threaded fastener therethrough for attachment of he bracket to the railing member.

In yet another embodiment, each of the plurality of brackets has a bottom portion extending over a bottom surface of a railing member having at least one hole formed therein for receiving a threaded fastener therethrough for attachment of the bracket to the railing member.

In another embodiment, each of the plurality of brackets has a vertical wall portion having a plurality of apertures, each formed therein for pivotal attachment of the bracket at more than one location on the bracket.

In yet another embodiment, the base and upright member are releasably coupled together.

In still another embodiment, the plurality of brackets comprises at least one bracket having a first portion and a second portion angled relative to the first portion to allow coupling of two railing members at an angle that is equal to the angle between the first and second portions.

In yet another embodiment, the angle between the first and second portions is approximately 40 degrees.

In still another embodiment, the upright member is comprised of square metal tubing having a first plurality of holes extending through in a first direction for attachment of a first upper and a first lower bracket on a first side of the upright member and a second plurality of holes extending through in a second perpendicular direction for attachment of a second upper and second lower bracket to a second side of the upright member so that the first and second upper and lower brackets are perpendicular.

### BRIEF DESCRIPTION OF THE DRAWINGS

The following drawings illustrate exemplary embodiments for carrying out the invention. Like reference numerals refer to like parts in different views or embodiments of the present invention in the drawings. Those of ordinary skill in the art will realize that the following description of the present invention is illustrative only and not in any way limiting. Other embodiments of the invention will readily suggest themselves to such skilled persons.

FIG. 1 is a perspective front view of a first embodiment of a safety handrail system support in accordance with the principles of the present invention.

FIG. 2 is a perspective front view of a first embodiment of a bracket assembly in accordance with the principles of the present invention.

FIG. 3A is a perspective front view of a second embodiment of a bracket assembly in accordance with the principles of the present invention.

FIG. 3B is a perspective front view of the bracket illustrated in FIG. 3A coupled to a pair of rail members in accordance with the principles of the present invention.

FIG. 4 is a perspective front view of a pair of safety handrail system supports on a staircase in accordance with the principles of the present invention.

FIG. 5 is a perspective front view of a pair of safety handrail system supports on a staircase in accordance with the principles of the present invention.

FIG. 6 is a perspective front view of a pair of safety handrail system supports on a staircase with a rail member coupled thereto in accordance with the principles of the present invention.

FIG. 7 is a perspective front view of a pair of safety handrail system supports on a staircase with a pair of rail members coupled thereto in accordance with the principles of the present invention.

FIG. 8 is a perspective front view of a second embodiment of a safety handrail system support in accordance with the principles of the present invention.

FIG. 9 is a perspective front view of an alternative embodiment of a support post in accordance with the principles of the present invention.

### DETAILED DESCRIPTION OF THE ILLUSTRATED EMBODIMENTS

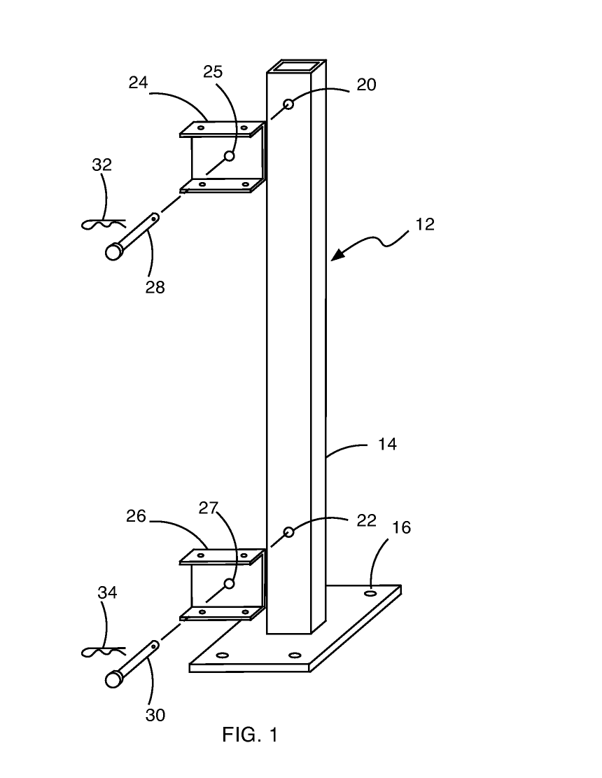

FIG. 1 illustrates a support post 12 for a handrail system according to the principles of the present invention. The support post 12 is comprised of an elongate upright member 14 rigidly and fixedly attached to a base 16 as by welding. The upright member 14 and base 16 may be comprised of metal, such as aluminum to keep weight down, of steel or of other materials known in the art. The base 16 is comprised of a flat plate having a plurality of holes 18 through which wood-type screws can be inserted to attach the base 16 to a surface, such as a step on a staircase or a floor. The base 16 may be of a size of about 4 inches square. The upright member 14 is comprised of a length of square tubing, such as 2 inch square tubing, through which transversely oriented holes 20 and 22 are provided. The holes 20 and 22 are positioned with the hole 20 (which extends through both side walls of the tubing 14) positioned near the top of the tubing 14 (e.g., 3 to 4 inches from the top) and the and the hole 22 (which also extends through both side walls of the tubing 14) positioned below and spaced from the hole 20 on the same side thereof (e.g., 6 to 7 inches from the bottom of the tubing). Mounting brackets 24 and 26 are configured to be attached to the upright member 14 with pins 28 and 30 and retaining pins 32 and 34, respectively. Each upright member 14 has a length sufficient to provide positioning of the upper bracket 24 so that the handrail (as shown and described herein) will be positioned about 40 inches above the support surface to which the plate 16 is attached. In order to be able to get at least two upright members fabricated from a single piece of raw tubing material and still meet OSHA requirements, the length of each upright member may made approximately 39 inches. The pins 32 and 34 may be of a length of about 2½ inches. Each bracket 24 and 26 includes a central aperture 25 and 27, respectively, for receiving the clips or pins 28 and 30, respectively. When mounted to the upright member 14, the brackets 24 and 26 can rotate relative to the upright member 14, the purpose of which will be more fully described herein.

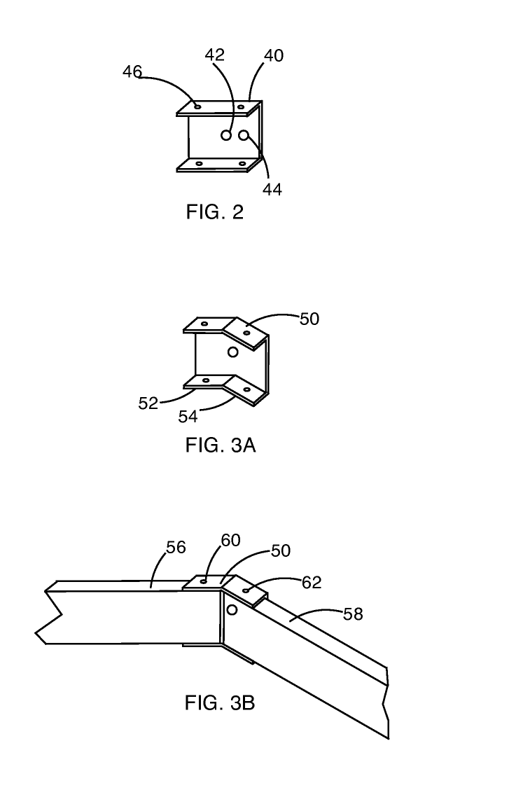

As shown in FIG. 2, a mounting bracket 40 may include a plurality of apertures 42 and 44 to allow mounting of the bracket 40 to the upright member 14 in various orientations. Also, the mounting bracket 40 includes a plurality of mounting holes 46 to allow the mounting bracket to be attached to a wood beam, such as a common 2×4, that, as will be described in more detail, forms the hand rail and/or safety rail of the hand rail system of the present invention. For such an application, the bracket 40 may have a length of about 5 inches and a width of about 3⅝ inches for receiving in a close fit manner a 2×4 section of a wood stud.

As illustrated in FIGS. 3A and 3B, another embodiment of a mounting bracket 50 according to the present invention is illustrated. The mounting bracket 50 includes a first portion 52 configured similarly to the mounting bracket 40 and a second portion 54 that is downwardly angled. The bracket 50 may be formed from steel or aluminum or other materials known in the art. As shown in FIG. 3B, the mounting bracket 50 allows for two lengths 56 and 58 of a hand rail to be mounted to the mounting bracket 50 so that each length 56 and 58 are oriented at an angle to one another, such as at an angle of about 40 degrees, and more particularly at an angle of 38 degrees. Each portion 52 and 54 may be of a length of about 3 inches with an approximately 2-inch depth and approximately 3⅝ inch spacing between the top and bottom sides to receive a pair of 2×4 inch studs 56 and 58 therein. The studs 58 and 58 may be provided with angled mating ends to fit against each other when inserted into the bracket 50. The studs 58 and 60 are then held to the bracket with screws 60 and 62 that re threaded into the studs 58 and 60 to hold the studs to the bracket 50. While trimming of the ends of the studs 56 and 58 may be desired, it is not necessary since the studs 58 and 60 will fit within the bracket 50 without trimming.

In addition, the length of the studs can be preserved when they are attached to the railing system of the present invention so as to allow later usage of the studs by being removed from the railing system when no longer needed. That is, because the studs are attached to the brackets as through holes 46 (see FIG. 2), or holes 60 and 62 (see PG. 3B) with sheetrock screws or other similar threaded fasteners, the screws can be quickly removed when disassembling the railing system to allow not only reuse of the railing system components, such as the brackets and upright support members, but the studs used to form the rails of the railing system of the present invention. Thus, standard length studs, whether 2×4, 2×6 or studs, which typically come in 8 or 10 foot lengths, of other dimensions and identification can be used in accordance with the principles of the present invention without having to modify the length of the stud to be used in the railing system of the present invention.

In new construction of homes and buildings, it is often the case that a staircase, balcony or other similar structure is built and it is some time during the construction process before a finish railing system will be installed, These staircases and balconies, however, are used during the construction phase to haul materials and to access other areas of the structure in which construction is ongoing. Sometimes, temporary railing systems will be installed by the contractor that comprise stud materials that are nailed to the stair case or other structure. Such temporary structures, however, are not very stable and may not provide adequate safety protection for contractors and workers. The present invention utilizes the very stud materials that are present on site during a construction project to be used to form a safety railing system according to the principles of the present invention.

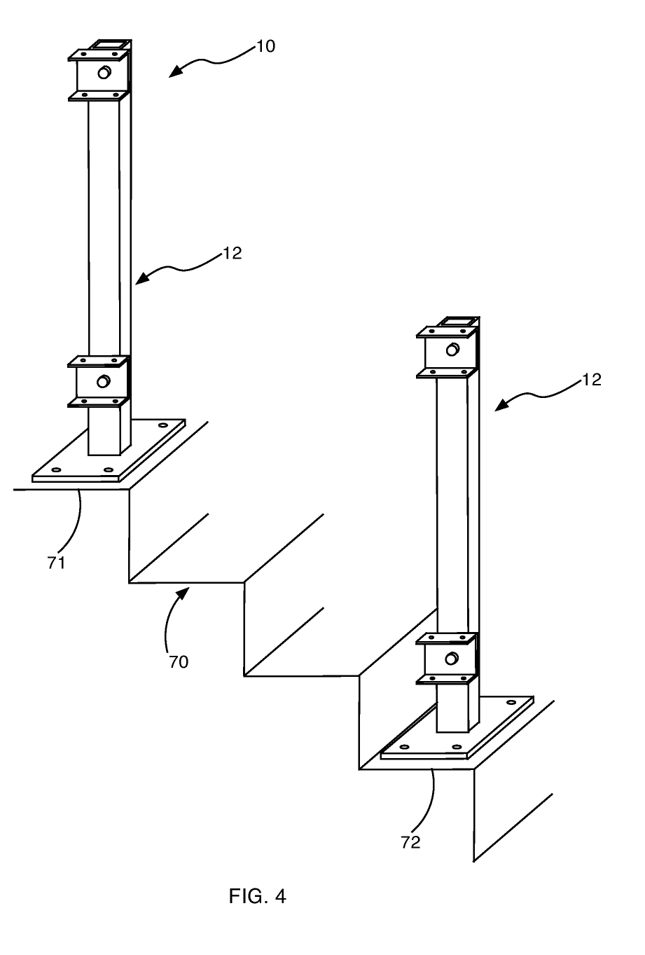

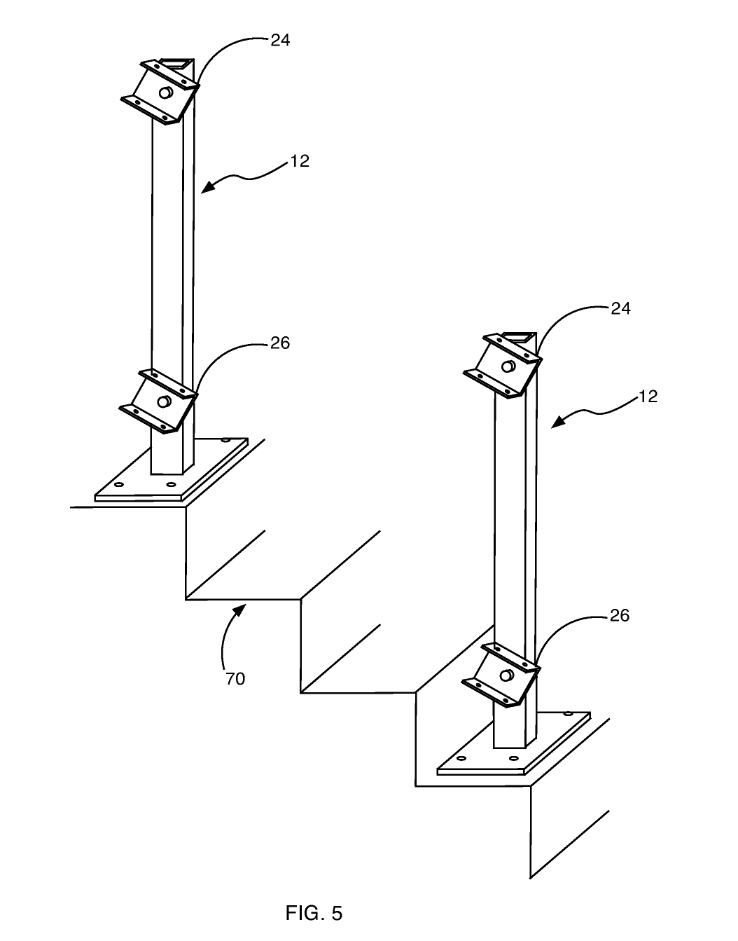

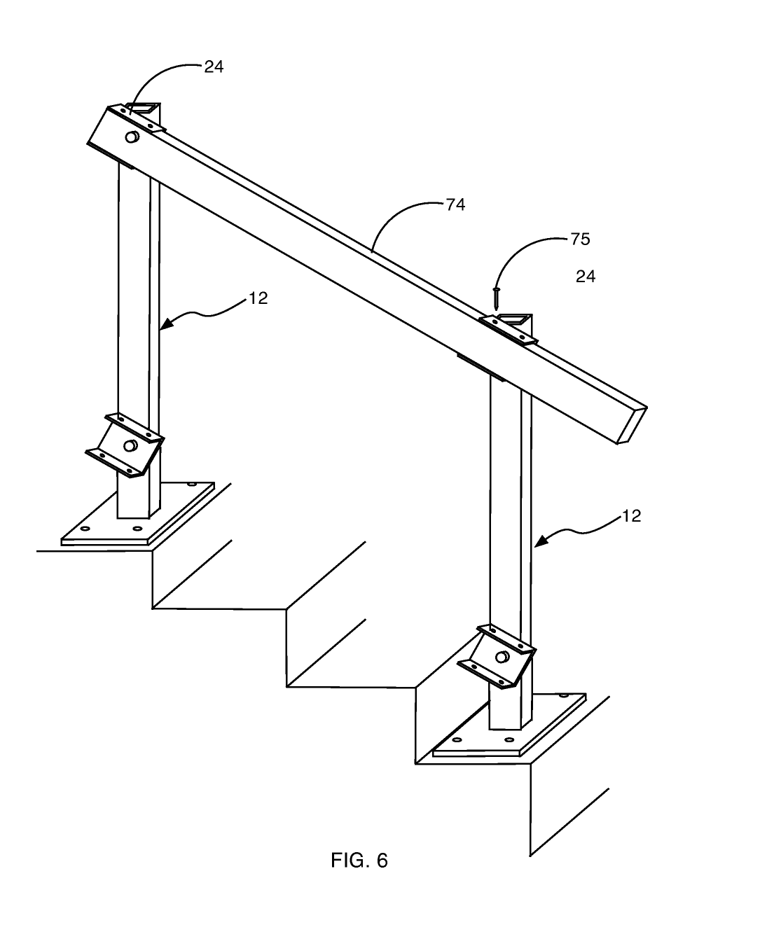

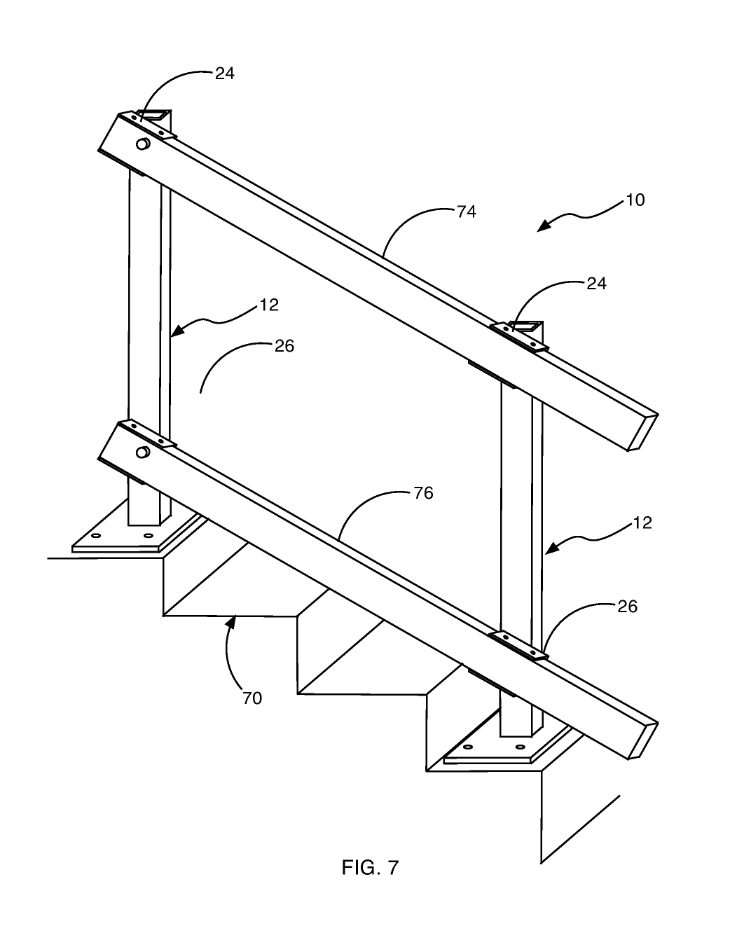

As shown in FIG. 4, in order to form a temporary safety railing system generally indicated at 10, in accordance with the principles of the present invention, at least two support posts 12 are mounted to a support surface, such as a staircase 70. The support posts 12 are fixedly, but removably, attached to different steps 71 and 72 and are positioned along the same side of the steps 71 and 72 as in a position where a finished handrail might be located. The support posts 12 may be spaced two, three or more steps apart. As further illustrated in FIG. 5, the mounting brackets 24 and 26 are rotated to match the angle of rise of the staircase 70, which may be about 40 degrees from horizontal. As shown in FIG. 6, an upper rail member 74 is attached, as with nails or screws 75, to the upper brackets 24 of the support structures 12. Thus, the upper rail member 74 spans the entire distance between brackets 24. As shown in FIG. 7, a bottom rail member 76 is attached, as with nails or screws, to the lower brackets 26, with the bottom rail member 76 spanning the distance between brackets 26. If additional railing sections are required, the top and bottom rail members 74 and 76 are laterally adjusted so that the ends of the rail members 74 and 76 are positioned midway in the brackets 24 and 26 so that additional upper and lower rail members 74 and 76 can be positioned within the brackets 24 and 26, abutted against the ends of the upper and lower rail members 74 and 76 and attached to the brackets 24 and 26 with fasteners inserted within the corresponding holes in the brackets 24 and 26, similar to the configuration illustrated in FIG. 3B. Where the upper support structure 12 is positioned at the top of a stair case 70 and forms a balcony thereafter, the upper support structure 12 brackets 24 and 26 may be replaced with the angled bracket 50 shown in FIG. 3A to allow the railing members to follow the contour of the support surface and thus transition from the upward angle of the steps to a horizontal surface defined by the balcony. Likewise, if the lower end of the railing system 10 is to transition to a lower balcony, the angled bracket 50 could be rotated 180 degrees and employed to continue the railing system 10 along a lower horizontal surface. Thus, the railing system 10 of the present invention is configured to be able to form a continuous railing system along various inclined and flat surfaces.

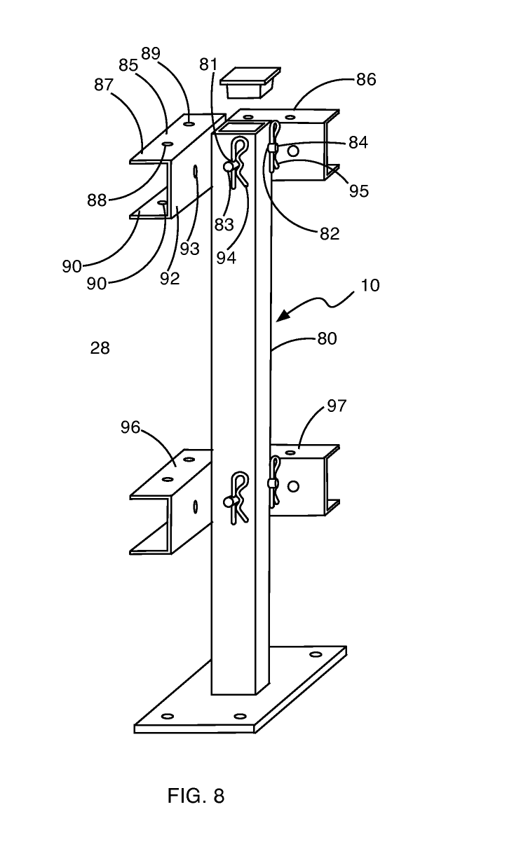

In addition, as illustrated in FIG. 8, the railing system 10 of the present invention can be configured to interconnect the railing system around a corner. Accordingly, a post 80 is provided with through holes 81 and 82 proximate in a top portion of the post 80 that extend through the post 80 at a ninety-degree angle to one another. The holes 81 and 82 are configured to receive clevis pins 83 and 84, respectively, that have the same configuration as the pins 28 and 30 illustrated in FIG. 1. The clevis pins 83 and 84 are provided to mount the mounting brackets 85 and 86, respectively, to the post 80 at a ninety-degree angle to one another. The mounting brackets 85 and 86 have the same configuration and are configured similarly to the mounting bracket 40 shown in FIG. 2. That is, the bracket 85 has a generally C shaped construction with a top wall 87 defining a pair of stud mounting holes 88 and 89, a bottom wall 90 having similarly configured mounting holes (only hole 91 of which is visible) and a vertically extending back wall 92 that defines a pair of holes (only hole. 93 of which is visible) for receiving the pin 84 there through in order to mount the bracket 85 to the post 80. Hairpin cotter pins 94 and 95 are inserted through transversely extending holes in the clevis pins 83 and 84 in order to provide temporary and removable attachment of the brackets 85 and 86 to the post 80. Because the mounting brackets 85 and 86 are each provided with a pair of mounting holes, such as mounting hole 93 of bracket 85, the mounting brackets 85 and 86 can be positioned such that one side thereof does not extend substantially beyond an edge of the post 80. This allows the two mounting brackets 85 and 86 to have their adjacent sides positioned proximate to one another so that when wood studs are inserted within the brackets 85 and 85, the mounting brackets 85 and 86 and attached wood studs do not interfere with each other at the post 80.

In order allow insertion and passage of the clevis pins 83 and 84 through the post 80 at the same time as illustrated, the holes 81 and 82 through which they are respectively inserted are vertically offset relative to a longitudinal axis of the post 80. As such, the holes 81 is positioned slightly lower than the hole 82 of a distance at least equal to a width of the clevis pins 83 and 84 to allow the clevis pins 83 and 84 to simultaneously be mounted to the post 80 without interference with one another. As such, as illustrated in FIG. 8, the mounting bracket 85 is positioned slightly higher than the mounting bracket 86 when mounted to the post 80. A similar configuration of mounting brackets 96 and 97 are attached to the post 80 at a lower portion of the post 80 for attachment of a coordinating pair of studs to form top rails with the upper brackets 85 and 86 and bottom rails with the lower brackets 96 and 97 so as to form upper and lower rails that form a ninety degree corner. It should be recognized, however, that other posts and bracket assemblies may be formed in accordance with the principles of the present invention. For example, by using a circular tube for the post with mounting holes at various radial angles, corners of various angles can be formed to accommodate railing system configurations where a lateral angle in the railing system is desired but at an angle other than 90 degrees.

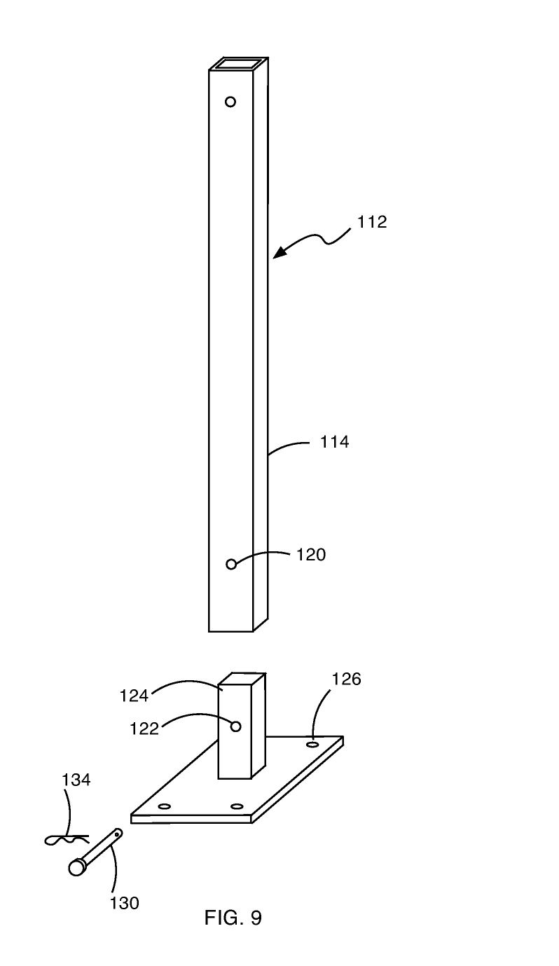

As further illustrated in FIG. 9, an alternative embodiment of a support post 112 for a handrail system according to the principles of the present invention is depicted. The support post 112 is comprised of an elongate upright member 114 coupled to a base 116 as with retaining pin 130 that is inserted through holes 120 in the upright post member 114 and through holes 122 in post support member 124 that is attached to the base plate 126, as by welding. The upright member 114 may be comprised of metal, such as aluminum to keep weight down, of steel or of other materials known in the art and may be formed from a hollow square tube, or a round tube as may be desired. The upright member 114 is inserted over the post support member 124 and held to the base 126 with retaining pin 130 that is inserted through both the upright member 114 and the support post 124 and secured with pin 134. In this example, the lower mounting bracket, such as brackets 96 or 97 illustrated in FIG. 8 could also be held with the pin 130 so that the pin 130 serves a dual purpose for both a bottom bracket and assembling the upright member 114 to the support post 124. It should also be recognized that the support post 124 could be larger than the outer perimeter of the upright member 114 and be hollow to allow insertion and attachment of the upright member 114 to the support post 124 in a manner that is effectively opposite to that previously described.

Thus, while certain illustrated embodiments have been shown, it will be apparent to those skilled in the art that some other configurations of a hand rail assembly, other uses of such a hand rail assembly or certain modifications can be employed in a manner consistent with the teachings of the present invention without departing from the inventive concepts herein. Thus, while there have been described various embodiments of the present invention, those skilled in the art will recognize that other and further changes and modifications may be made thereto without department from the spirit of the invention, and it is intended to claim all such changes and modifications that fall within the true scope of the invention. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods and structures of the present invention are described herein, any methods or structures similar or equivalent to those described herein may be used in the practice or testing of the present invention. All references cited herein are incorporated by reference in their entirety and for all purposes. In addition, while the foregoing advantages of the present invention are manifested in the illustrated embodiments of the invention, a variety of changes can be made to the configuration, design and construction of the invention to achieve those advantages including combinations of components of the various embodiments. Hence, reference herein to specific details of the structure and function of the present invention is by way of example only and not by way of limitation.

What is claimed is:

1. A temporary safety railing system, comprising:
a plurality of upright support structures, each support structure comprising a base member configured for temporary attachment to a support surface, an upright member attached to the base member and extending perpendicularly therefrom, a plurality of C-shaped mounting brackets rotatably attached to each upright member on the same side thereof in a longitudinally spaced relationship with an upper mounting bracket positioned proximate a top end of each upright member and a lower mounting bracket positioned a distance below said upper mounting bracket; and
a plurality of wood railing members with upper railing members attached to said upper mounting brackets and lower railing members attached to said lower mounting brackets, the upper and lower railing members spanning a distance between adjacent support structures.

2. The system of claim 1, wherein each of the plurality of mounting brackets are releasably attached to the plurality of support structures.

3. The system of claim 1, wherein the railing members are comprised standard studs.

4. The system of claim 1, wherein each of the railing members are attached to the plurality of brackets with a plurality of threaded fasteners that can be removed after use.

5. The system of claim 1, wherein each of the plurality of brackets has a top portion for extending over a top surface of a railing member having at least one hole formed therein for receiving a threaded fastener therethrough for attachment of the bracket to the railing member.

6. The system of claim 1, wherein each of the plurality of brackets has a bottom portion extending over a bottom surface of a railing member having at least one hole formed therein for receiving a threaded fastener therethrough for attachment of the bracket to the railing member.

7. The system of claim 1, wherein each of the plurality of brackets has a vertical wall portion having a plurality of apertures, each formed therein for pivotal attachment of the bracket at more than one location on the bracket.

8. The system of claim 1, wherein the base and upright member are releasably coupled together.

9. The system of claim 1, wherein the plurality of brackets comprises at least one bracket having a first portion and a second portion angled relative to the first portion to allow coupling of two railing members at an angle that is equal to the angle between the first and second portions.

10. The system of claim 9, wherein the angle between the first and second portions is approximately 40 degrees.

11. The system of claim 1, wherein the upright member is comprised of square metal tubing having a first plurality of holes extending through in a first direction for attachment of a first upper and a first lower bracket on a first side of the upright member and a second plurality of holes extending through in a second perpendicular direction for attachment of a second upper and second lower bracket to a second side of the upright member so that the first and second upper and lower brackets are perpendicular.

12. A method of installing a temporary safety railing system, comprising:
providing a plurality of upright support structures, each support structure comprising a base member configured for temporary attachment to a support surface, an upright member attached to the base member and extending perpendicularly therefrom, a plurality of C-shaped mounting brackets rotatably attached to each upright member on the same side thereof in a longitudinally spaced relationship with an upper mounting bracket positioned proximate a top end of each upright member and a lower mounting bracket positioned a distance below said upper mounting bracket;
providing a plurality of wood railing members with upper railing members attached to said upper mounting brackets and lower railing members attached to said lower mounting brackets, the upper and lower Ming members spanning a distance between adjacent support structures;
attaching the plurality of support structures to an edge of a staircase or balcony;
attaching the upper and lower brackets to the plurality of support structures; and
attaching a plurality of railing members to the upper and lower brackets.

13. The system of claim 12, further comprising providing the railing members in the form of standard studs.

14. The method of claim 12, further comprising attaching the railing members to the plurality of brackets with a plurality of threaded fasteners that can be removed after use.

15. The method of claim 14, further comprising disassembling the railing members from the brackets by unscrewing threaded fasteners from the brackets that are holding the railing members to the brackets.

16. The method of claim 14, further comprising providing each of the plurality of brackets with a top portion for extending over a top surface of a railing member having at least one hole formed therein for receiving a threaded fastener therethrough for attachment of the bracket to the railing member.

17. The method of claim 12, further comprising providing each of the plurality of brackets with a bottom portion extending over a bottom surface of a railing member having at least one hole formed therein for receiving a threaded fastener therethrough for attachment of the bracket to the railing member.

18. The method of claim 12, further comprising providing each of the plurality of brackets with a vertical wall portion having a plurality of apertures, each formed therein for pivotal attachment of the bracket at more than one location on the bracket.

19. The method of claim 12, further comprising releasably coupling the base and upright member together.

20. The method of calm 12, further comprising providing at least one bracket with a first portion and a second portion angled at approximately 40 degrees relative to the first portion to allow coupling of two railing members at an angle that is equal to the angle between the first and second portions.
